(19) United States
(12) Patent Application Publication
(10) Pub. No.: US 2013/0016094 A1
(43) Pub. Date: Jan. 17, 2013

(54) VERGENCE CONTROL METHOD FOR STEREO-SCOPIC IMAGE CONTROL AND PORTABLE DEVICE SUPPORTING THE SAME

(71) Applicants: Jeong Heui CHO, Ansan-si (KR); Je Han YOON, Seongnam-si (KR)

(72) Inventors: Jeong Heui CHO, Ansan-si (KR); Je Han YOON, Seongnam-si (KR)

(73) Assignee: SAMSUNG ELECTRONICS CO. LTD., Suwon-si (KR)

(21) Appl. No.: 13/547,570

(22) Filed: Jul. 12, 2012

(30) Foreign Application Priority Data
Jul. 12, 2011 (KR) 10-2011-0069028

(51) Int. Cl. G06F 3/041; G06T 15/00

(52) U.S. Cl. 345/419; 345/173

(57) ABSTRACT

A vergence control method for controlling a stereoscopic display is provided. The method comprises reproducing a stereoscopic image, receiving an input signal for vergence view adjustment of the stereoscopic image, and adjusting a vergence view so that a position corresponding to the received input signal becomes the vergence view by removing a parallax of image frames of the position.

### PRIORITY

This application claims the benefit under 35 U.S.C. §119(a) of a Korean patent application filed on Jul. 12, 2011 in the Korean Intellectual Property Office and assigned Serial No. 10-2011-0069028, the entire disclosure of which is hereby incorporated by reference.

### BACKGROUND OF THE INVENTION

1. Field of the Invention

The present invention relates to a stereoscopic image control. More particularly, the present invention relates to a vergence control method for controlling a stereoscopic image so that a user-desired area becomes vergence, and a portable device supporting the same.

2. Description of the Related Art

One method of generating a 3D image is providing a user with different images of a scene for each eye. Two different polarized images are displayed in one screen, and the user wears a polarizing filter corresponding to each eye, by which a 3D image is implemented.

In order to implement a 3D image, an autostereoscopic display or 3D display method may employ an opening or slit array linked with a 2D display. The basic idea of the autostereoscopic 3D display method is that the user sees different portions of the 2D image with each eye when the user sees a 2D image through a slit array positioned a preset distance from the screen. When an appropriate image is rendered and is displayed in a 2D display, the user sees different perspective images with each eye without a filter. A 3D display method according to the parallax of the two eyes may be used. The autostereoscopic method and two eye parallax method may support a non-eyeglass 3D method.

For content supporting a stereoscopic image display, a content producer produces content based on a certain angle. The focal point of the image output to the display unit is determined based on the view desired by the content producer. When the user views content supporting a stereoscopic image, if the user sees a separate area without seeing the view designated by the producer, the focal points of the area may not coincide with each other. For example, when the content producer determines the vergence view of the content supporting the stereoscopic image display as the bottom-right point and produces content accordingly, the viewer may view an image which has the right focus when gazing at a bottom-right area. However, if the viewer gazes at a certain area of the upper-left side, the focal points would not coincide with each other, and the image would be viewed separately. This may cause eye strain and make the viewer uncomfortable.

### SUMMARY OF THE INVENTION

Aspects of the present invention have been made to address the above-mentioned problems and/or disadvantages described below. Accordingly, an aspect of the present invention is to provide a vergence control method for controlling a stereoscopic image display which supports to adjust the point desired by user as the vergence view, and a terminal supporting the same.

In accordance with an aspect of the present invention, a vergence control method for controlling a stereoscopic display. The method includes reproducing a stereoscopic image, receiving an input signal for vergence view adjustment of the stereoscopic image, and adjusting a vergence view such that a position corresponding to the received input signal becomes the vergence view by removing a parallax of image frames of the position.

In accordance with another aspect of the present invention, a terminal for supporting a vergence control for stereoscopic image display control is provided. The terminal includes a display panel for outputting a screen according to a reproducing of a stereoscopic image, and a controller for performing vergence view adjustment such that a position corresponding to a received input signal becomes a vergence view by receiving an input signal for vergence view adjustment of the stereoscopic image, and for removing a parallax of image frames of the position corresponding to the received input signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 is a block diagram illustrating a terminal according to an exemplary embodiment of the present invention;

FIG. 2 is a block diagram illustrating a controller according to an exemplary embodiment of the present invention;

FIG. 3 is a block diagram illustrating a vergence adjustment unit according to an exemplary embodiment of the present invention;

FIG. 4 illustrates adjustment of a vergence view of a stereoscopic image according to an exemplary embodiment of the present invention;

FIG. 5 is a flowchart illustrating a method for controlling a vergence according to an exemplary embodiment of the present invention;

FIG. 6 illustrates scanning an area for a vergence view adjustment and adjusting an image frame according to an exemplary embodiment of the present invention; and

FIG. 7 illustrates a control of a vergence according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

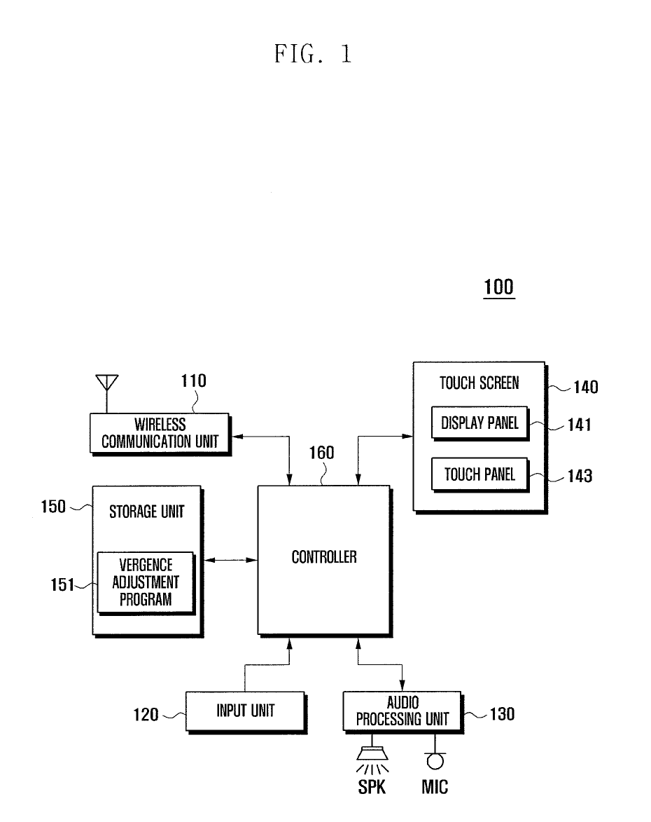

FIG. 1 is a block diagram schematically illustrating a terminal where a control of a vergence is applied for a stereoscopic image control according to an exemplary embodiment of the present invention.

Referring to FIG. 1, a portable terminal 100 may include a wireless communication unit 110, an input unit 120, an audio processing unit 130, a touch screen 140, a storage unit 150 and a controller 160. While the terminal is described herein as a portable terminal, the terminal may be any type of terminal supporting the display of stereoscopic images.

The portable terminal 100 supports a designated point to be a focus area by rearranging an image based on the area which the user desires to designate as a vergence view. The portable terminal 100 adjusts the image so that image focuses of the user-desired area coincide with each other in an environment where an image is displayed in multi levels, thereby minimizing uncomfortable feeling for a divided image. This enables a content producer for a multi-level image display to have enhanced image-making freedom.

The wireless communication unit 110 forms a communication channel for a voice call, a communication channel for a video call, and a communication channel for data transmission such as an image and a message, etc. under the control of a controller 160. The wireless communication unit 110 may receive data through a channel, and the received data may be output to a touch screen 140 according to the control of the controller 160. The data received by the wireless communication unit 110 may be content which supports stereoscopic image indication, for example, data corresponding to stereoscopic content. The stereoscopic content received by the wireless communication unit 110 may be displayed with a certain area as the vergence view by a default. The vergence view may be changed according to the terminal setting.

The input unit 120 includes input keys and function keys for inputting number or letter information and setting various functions. The function keys may include a direction key, a side key, a shortcut key, etc., which are set to perform a certain function. The input unit 120 generates a key signal related with user setting and terminal function control, and transmits the signal to the controller 160. The input unit 120 may generate an input signal for selecting a vergence view of a stereoscopic image output through the touch screen 140 according to user's control, and transmit the input signal to the controller 160. The input unit 120 may generate an input signal for changing a vergence view of stereoscopic content according to the user's selection.

The audio processing unit 130 includes a speaker (SPK) for replaying audio data and audio data of a music file or a video file, and a microphone (MIC) for collecting the user's voice or other audio signals while having a conversation through a video call. The audio processing unit 130 may replay corresponding audio data when audio data is included in stereoscopic content. When replaying stereoscopic content, if an input signal for adjusting a vergence view is generated, the audio processing unit 130 may output a notice sound according to the input signal, for example, a notice sound indicating a vergence view change. Such a notice sound output may be omitted according to a setting of the portable terminal 100.

The touch screen 140 displays information inputted by the user or information provided to the user as well as various menus of the terminal 100. The touch screen 140 may provide various screens according to the use of the terminal 100, for example, a waiting screen, a menu screen, a message writing screen, and a calling screen, etc. Such a touch screen 140 may be formed by, for example, a Liquid Crystal Display (LCD) or an Organic Light Emitting Diode (OLED).

The touch screen 140 includes a display panel 141 and a touch panel 143. The display panel 141 may be arranged to implement stereoscopic content. The touch panel 143 generates a touch event according to the user's touch and transmits the generated touch event to the controller 160. The user may generate a touch event indicating an area to be intended to be viewed using the touch panel 143. The function of a vergence view change through the touch screen 140 is described below.

The storage unit 150 stores data to be output to the touch screen 140 as well as application programs for operating a function according to an exemplary embodiment of the present invention, and stores a key map or a menu map for operating the touch screen 140, and information about a touch lock release area, etc. The key map and the menu map may have various forms. The storage unit 150 may store a vergence adjustment program according to an exemplary embodiment of the present invention.

When stereoscopic content is output to the display panel 141, the vergence adjustment program 151 automatically activates a vergence adjustment angle or activates a vergence adjustment function according to user's request. When an input signal for replaying stereoscopic content is generated, the vergence adjustment program 151 is loaded in the controller 160, and supports a function for adjusting the vergence. The vergence adjustment program 151 may include a routine for monitoring a replay of stereoscopic content, a routine for collecting a vergence view designation input signal for vergence adjustment automatically or according to user setting when replaying stereoscopic content, and a routine for rearranging stereoscopic content according to a vergence designation input signal generated when a vergence view designation input signal is generated.

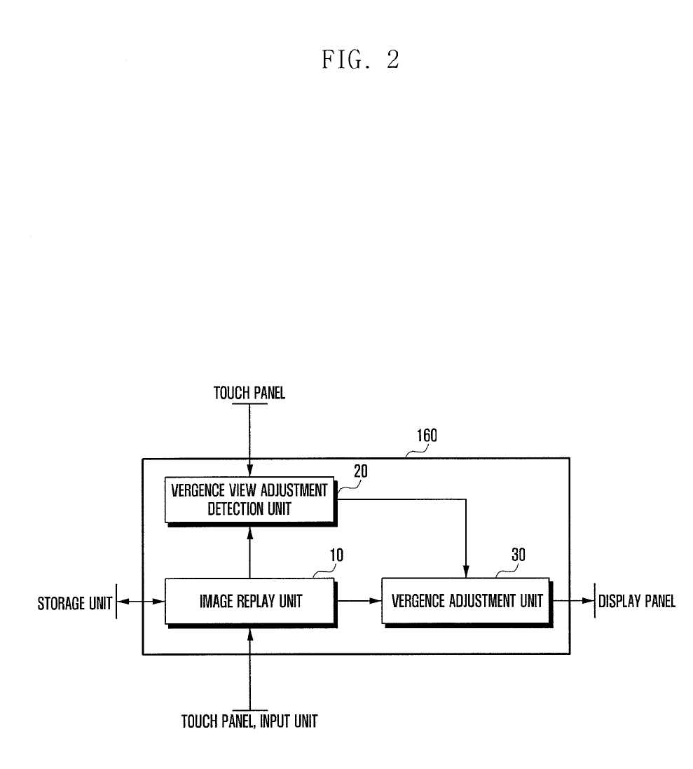

The controller 160 controls power supply to each component of the portable terminal 100 so that the initialization process for each component may be performed. The controller 160 may perform a signal flow control for controlling vergence adjustment according to an exemplary embodiment of the present invention. The controller 160 may be configured as illustrated in FIG. 2.

FIG. 2 is a block diagram illustrating a controller according to an exemplary embodiment of the present invention.

Referring to FIG. 2, the controller 160 may include a vergence view adjustment detection unit 20, an image replay unit 10, and a vergence adjustment unit 30.

The image replay unit 10 replays stereoscopic content stored in the storage unit 150 according to input signals input from at least one of the touch panel 143 and the input unit 120, and stereoscopic content received by the wireless communication unit 110. Such an image replay unit 10 may be configured in various forms according to characteristics of replayed content. The image replay unit 10 may include a video codec, a stereo video codec, an image codec, a stereo image codec, a 3D graphic, and a graphic library or a stereo graphic library, etc. The image replay unit 10 may output a general still image, and video data included in moving pictures and a game, etc., and perform data processing for outputting video data included in a stereoscopic still image, a stereoscopic moving picture, a stereoscopic game, and a stereoscopic AR, etc.

The image replayed by the image replay unit 10 is supplied to the display panel 141 via the vergence adjustment unit 30. The replayed image may be stored in advance in the frame buffer of the display panel 141 and output to the display panel 141. The image replay unit 10 may provide a menu screen for a replay of stereoscopic content. The user may generate an input signal requesting a replay of stereoscopic content through the corresponding menu screen. When an input signal for requesting a replay of stereoscopic content is generated, the image replay unit 10 may transmit the generated signal to the vergence view adjustment detection unit 20.

The vergence view adjustment detection unit 20 determines whether an input signal for vergence view adjustment has been generated from at least one of the touch panel 143 and the input unit 120. When the vergence view adjustment detection unit 20 receives a signal indicating a replay of 3D content from the image replay unit 10, the vergence view adjustment detection unit 20 may be activated and determine whether an input signal for vergence view adjustment has been generated. When the vergence view adjustment detection unit 20 receives a signal indicating a replay of 3D content from the image replay unit 10, the vergence view adjustment detection unit 20 may determine whether a preset touch event has occurred from the touch panel 143. When a preset touch event occurs, the vergence view adjustment detection unit 20 may transmit to the vergence view adjustment unit 30 an input signal for vergence view adjustment corresponding to location information of a position where the touch event has occurred.

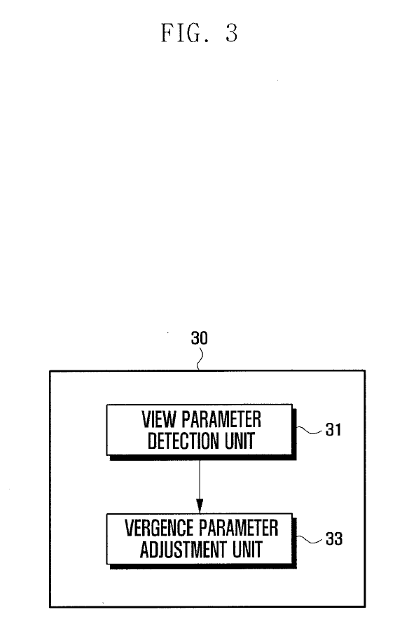

The vergence view adjustment unit 30 performs vergence view adjustment based on an input signal for vergence view adjustment transmitted from the vergence view adjustment detection unit 20. The vergence view adjustment unit 30 may transmit adjusted image data to the display panel 141. The vergence view adjustment unit 30 may have a configuration as illustrated in FIG. 3.

FIG. 3 is a block diagram illustrating a vergence adjustment unit 30 according to an exemplary embodiment of the present invention.

Referring to FIG. 3, the vergence adjustment unit 30 may include a view parameter detection unit 31 and a vergence parameter adjustment unit 33.

The view parameter detection unit 31 detects a parameter for the view of 3D content. 3D content may be produced by photographing images by multiple cameras. For example, in order to produce 3D content, two cameras may photograph a subject at different angles from different positions, and the two camera images may be combined and expressed stereoscopically. Consequently, two or more images are arranged at constant angles and by layers, and a certain object included in the corresponding images is stereoscopically expressed for 3D content. In this process, instead of stereoscopically expressing a certain object, focal points of other objects included in the image do not coincide with each other, and thus the object may be displayed separately. Likewise, in order for a certain object included in 3D content images to be expressed stereoscopically, focal points should coincide with each other, and various parameters may be adjusted for this purpose according to the arranged state of a plurality of images.

Objects in the image may have a parameter for the view. The parameter for the view may be used to match the parallaxes of a certain object. The view parameter detection unit 31 may detect the parameter for the view of the certain object as described above. The parameter for the detected view is transmitted to the vergence parameter adjustment unit 33. The object may include all elements constituting an image, such as a background object included in the image and an object corresponding to a certain object positioned on the background object.

The vergence parameter adjustment unit 33 adjusts the parameter for the view of a stereoscopic image detected by the view parameter detection unit 31 according to a vergence view adjustment input signal. The vergence view parameter adjustment unit 33 may determine location information of the display panel 141 corresponding to the vergence view adjustment input signal, and adjust the view of objects of the image corresponding to the location information to become the vergence view. The objects of the image may be the elements which are arranged in the position on the display panel 141 indicated by the vergence view adjustment input signal among various elements constituting the image.

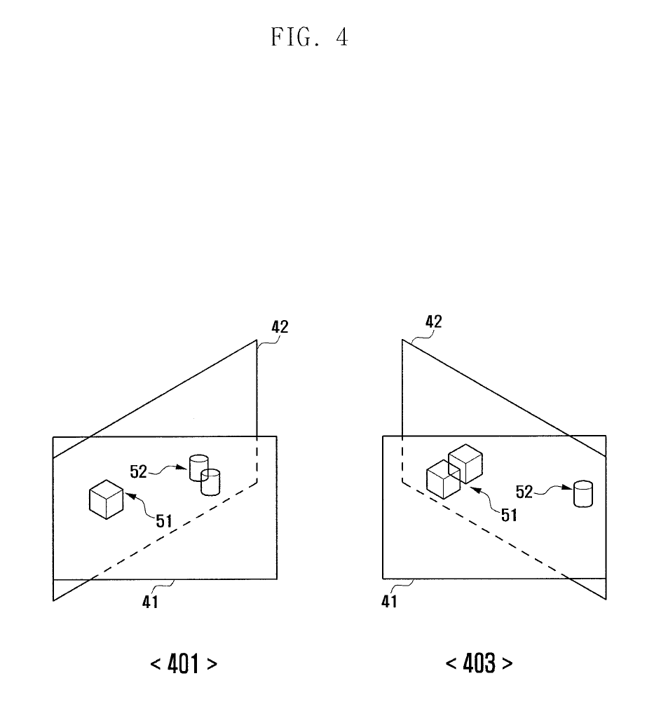

The vergence parameter adjustment unit 33 adjusts view or parallax parameters of the area indicated by the vergence view adjustment input signal so that the views or parallaxes of the area coincide with each other. For example, when a plurality of images overlap at a certain angle for implementation of a stereoscopic image, the vergence parameter adjustment unit 33 may adjust parameters in order to adjust the displayed angle of the plurality of images and the overlapped position of each of the images, as described below with reference to FIG. 4.

FIG. 4 illustrates adjustment of a vergence view of a stereoscopic image according to an exemplary embodiment of the present invention. In the example shown in FIG. 4, two image frames are used for implementation of a stereoscopic image for the convenience of explanation.

Referring to FIG. 4, in order to implement a stereoscopic image, a first image frame 41 and a second image frame 42, which are photographed at different angles, may be arranged to overlap so that a certain view becomes the vergence view by a default setting or according to the setting of a stereoscopic producer. The overlapping level of the first image frame 41 and the second image frame 42 may be defined by parameters which are applied in outputting the first image frame 41 and the second image frame 42 in the display panel 141. If parameters are defined in a manner that the first object 51 included in the first image frame 41 and the second image frame 42 becomes the vergence view, the views of the first object of the first image frame 41 and the second image frame 42 coincide with each other as shown in the screen 401, and thus the first object 51 may be displayed as a stereoscopic image. As the vergence view is defined in the first object 51, the parallaxes of the second object 52 positioned in the first image frame 41 and the second image frame 42 do not coincide with each other, and thus a separated image may be displayed.

If the user requests that the views of the second object 52 coincide with each other, for example, by generating a vergence view adjustment input signal so that the second object 52 becomes the vergence view, the vergence parameter adjustment unit 33 may adjust the view parameters so that the views of the second object 52 coincide with each other. To this end, the view parameters related with the second object 52 may be collected. This may include collecting parallaxes between the second object 52 of the first image frame and the second object 52 of the second image frame. The parallax parameter may be detected by the view parameter detection unit 31, and may be transmitted to the vergence parameter adjustment unit 33.

If there is a request for vergence view adjustment of the second object 52, the vergence parameter adjustment unit 33 may adjust the displayed angle of the first image frame 41 and the second image frame 42 so that the parallax of the second object 52 is removed. Accordingly, a stereoscopic image, in which the second object 52 becomes the vergence view, may be output to the display panel 41 as shown in the screen 403. As the vergence view is changed to the second object 52, the first object 51 may be displayed as a separated image.

As described above, the vergence parameter adjustment unit 33 may adjust the vergence view of a stereoscopic image according to user's request by producing the view parameter of the area in which the vergence view has been changed based on a vergence view adjustment input signal which the user generates for vergence view adjustment, and controlling to adjust the position of image frames so that the parallax is removed in the produced view parameter.

The vergence view adjustment detection unit 20 may perform an input signal search for vergence view adjustment using a camera. The portable terminal 100 may include a camera for this purpose. The vergence view adjustment detection unit 20 may control to activate the camera for vergence view adjustment. When the image replay unit 10 replays stereoscopic content, the vergence view adjustment detection unit 20 may control to automatically activate the camera. The camera may photograph the user's face, and specifically the user's eyes, and the photographed image may be provided to the vergence view adjustment detection unit 20.

The vergence view adjustment detection unit 20 may determine the position currently indicated by user's eyes based on the position of the eyes included in the image transmitted by the camera, and determine the position as the vergence view adjustment input signal. The vergence view adjustment detection unit 20 may call an image recognition database for determining the vergence view based on the eye in the storage unit 150, and may recognize the distance with the portable terminal 100 based on the size of the eye and other factors, and recognize the direction to which the eye is directed according to the position of the iris of the eye. Based on the distance and the direction, the vergence view adjustment detection unit 20 may identify a location on the display panel 141 where the user is looking, and generate the above described vergence view adjustment input signal. The vergence adjustment unit 30 may adjust the vergence view through frame indication angle adjustment as described above with respect to the vergence view adjustment input signal transmitted by the vergence view adjustment detection unit 20 based on the camera image.

Components of the portable terminal 100, which supports vergence adjustment of a stereoscopic image, and the role of each component have been described above. A method of controlling vergence by operating the portable terminal 100 is described below.

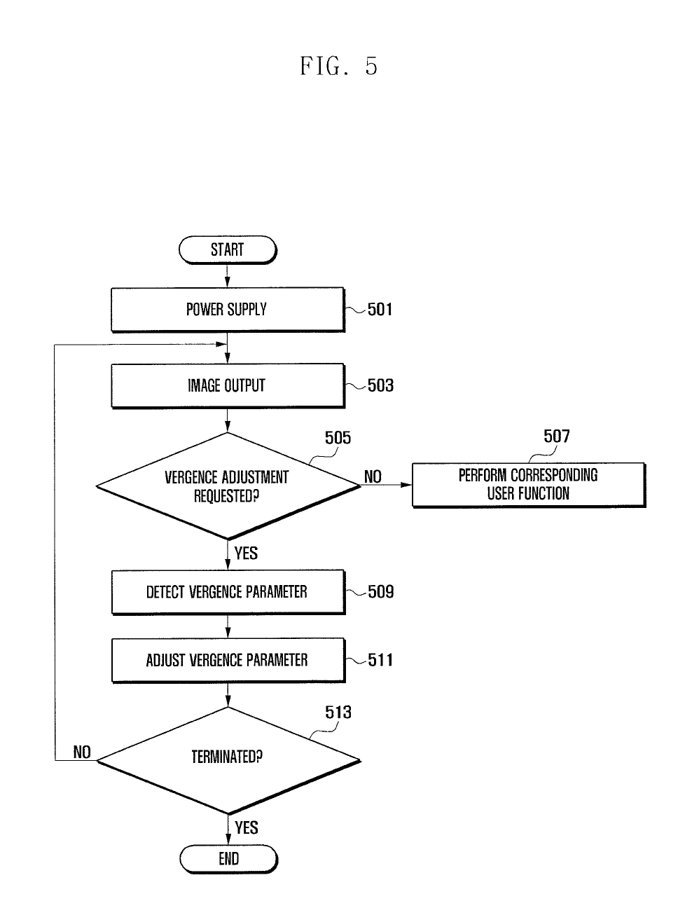

FIG. 5 is a flowchart illustrating a method for controlling a vergence according to an exemplary embodiment of the present invention.

Referring to FIG. 5, power is supplied to the terminal 100 for operation of the terminal 100 in step 501. In order to supply power, the user may connect a battery or charger of the portable terminal 100, and generate an input signal or power supply. When power is supplied, the portable terminal 100 generates power for operating each component of the portable terminal 100 using the supplied power, and initializes each component using the generated power. When the initialization is completed, the portable terminal 100 may control to output an idle screen in the touch screen 140 according to preset schedule information.

The portable terminal 100 may activate user functions according to an input signal generated from the input unit 120 and an input signal generated from the touch screen 140 of a touch screen function. In step 503, the portable terminal 100 outputs an image corresponding to user function activation in the touch screen 140. The image output at step 503 may correspond to stereoscopic content. The stereoscopic content may be stored as a file, and output to the touch screen 140 according to generation of an input signal. The stereoscopic content may be received from through the wireless communication unit 110, and output to the touch screen 140.

While stereoscopic content is being output, the controller 160 determines whether an input signal corresponding to the vergence adjustment request has been generated in step 505. If stereoscopic content is displayed in the display panel 141, the controller 160 may control to automatically enter the vergence adjustment mode, or to enter the vergence adjustment mode according to generation of an input signal corresponding to user request. The vergence adjustment mode may be automatically set while the stereoscopic content is being output to the display panel 141. When the vergence adjustment mode has been set, the controller 160 may determine whether an input signal corresponding to the vergence view adjustment input signal, for example, an input signal corresponding to a touch event of a certain pattern or a touch event generated in a certain area, has been generated.

If an input signal corresponding to a separate vergence view adjustment has not been generated, the controller 160 controls to perform a user function corresponding to the input signal in step 507. For example, when an input signal for controlling a stereoscopic image replay is generated, the controller 160 may control to perform stereoscopic image replay control according to the input signal. When stereoscopic images related with a game are replayed, the controller 160 may control to perform processing for game performance according to the input signal.

When an input signal for vergence adjustment is generated at step 505, the controller 160 controls to detect a view parameter in step 509. The view parameters are view parameters of image frames provided for stereoscopic image implementation. The view parameters include information about the positions and distances of image frames output to the display panel 141, and may also include parallax values at a certain position of the display panel 141. The controller 160 detects view parameters of the positions where vergence view adjustment input signals have been generated when detecting the view parameter.

The controller 160 controls to adjust the vergence parameter based on the corresponding view parameter in step 511. The controller 160 may control to adjust at least one of the position, distance and angle of the image frames at a certain position where views do not coincide with each other. If the vergence parameter adjustment is completed, the controller 160 outputs image frames in which at least one of the position, distance and angle has been adjusted in the display panel 141, and may output the stereoscopic content so that the parallaxes of positions, where the vergence view adjustment input signals have been generated, coincide with each other. Accordingly, the stereoscopic image where the vergence view has been changed may be output to the display panel 141.

The controller 160 determines whether an input signal for function termination or terminal termination has been generated in step 513, and returns to step 503 if no such signal has been generated.

A method of automatically detecting the vergence view adjustment input signal using a camera may be applied to the step of determining the vergence adjustment request at step 505. After photographing the viewer's eyes using a camera, and predicting the viewer's viewing direction using the location and size of the iris from the photographed eyes, a vergence view adjustment input signal corresponding to the predicted viewing direction may be generated.

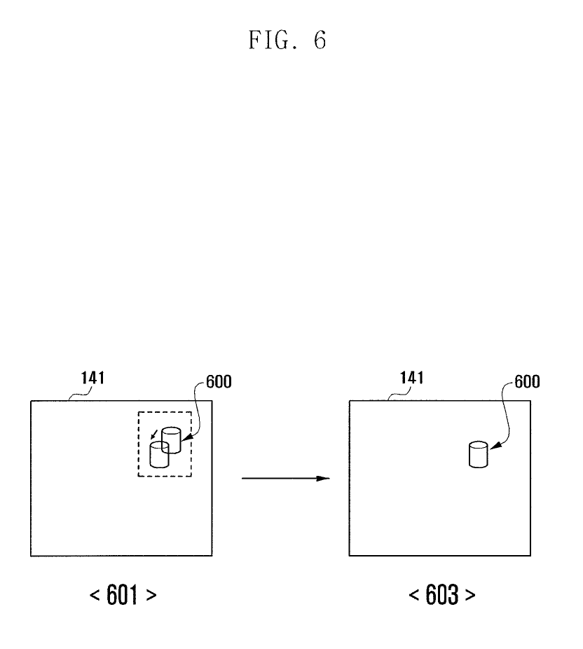

According to the method illustrated in FIG. 5, view parameters of image frames are detected, and image frames are adjusted to the position to where user desires to adjust the vergence view by adjusting the detected view parameters, thereby adjusting the vergence view of the stereoscopic image. However, exemplary embodiments of the present invention are not limited to this example. For example, as illustrated in FIG. 6, the vergence view adjustment method may detect images of a certain area of a position where a vergence view adjustment input signal has been generated among images output to the current display panel 141, and may perform vergence view adjustment through the image adjustment.

FIG. 6 illustrates scanning an area for a vergence view adjustment and adjusting an image frame according to an exemplary embodiment of the present invention.

Referring to FIG. 6, as shown in the screen 601, if two objects 600 are arranged at positions where views do not coincide with each other on the display panel 141 of the position designated as the vergence view to be adjusted, the controller 160 detects the boundary area of the objects 600 by scanning a certain area of the corresponding position. The controller 160 may determine the distances and directions between the boundary areas of the objects 600, and adjust image frames so that the boundary areas of two objects 600 coincide with each other as shown in the screen of reference numeral 603. Through such a method, the controller 160 may provide effects of changing the vergence view of the stereoscopic image based on the method by which the objects of a certain position become coincided with each other without adjustment of separate parameter detection and parameter adjustment.

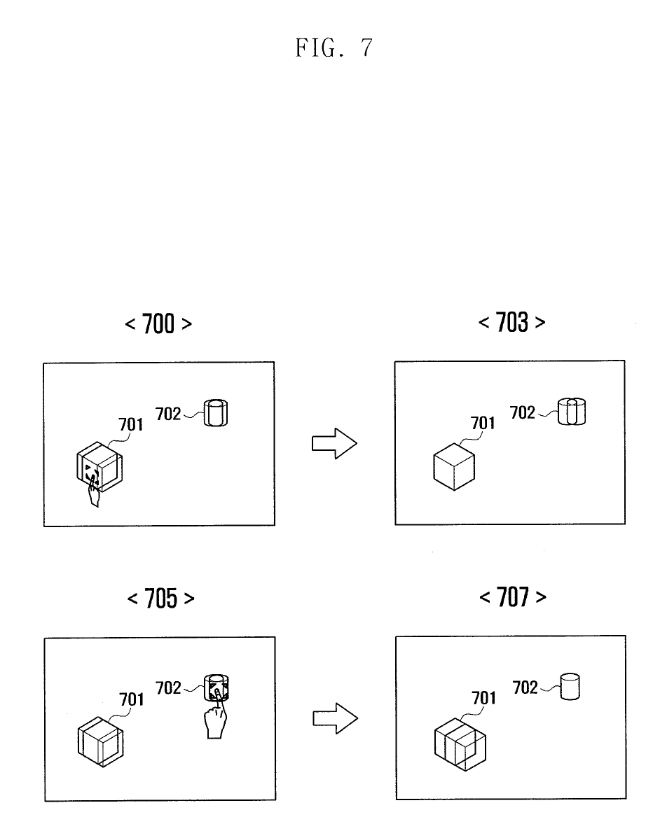

FIG. 7 is a screen example illustrating a change of a vergence view in a stereoscopic image according to an exemplary embodiment of the present invention.

Referring to FIG. 7, two image frames whose views do not coincide with each other may be output to the display panel 141 as illustrated in the screen 700. As shown in the screen 700, the vergence views are determined as a certain area of the center, and thus the areas except the center, for example, the bottom-left area where the object 701 is positioned and the upper-right area where the object 702 is positioned do not coincide with each other.

When the vergence adjustment mode has been set and the screen 700 is being provided as described above, the user may generate a touch event by touching the touch panel 143 on the bottom-left area where the object 701 is being output. The controller 160 may determine a touch event occurring in the area as an input signal for vergence view adjustment, and collect location information of the area. The controller 160 may detect view parameters and check the parallax values of the corresponding area. The controller 160 may control to adjust the output direction, distance and angle of image frames to remove the parallax value so that the vergence views of the area become coincided with each other. Accordingly, the vergence views of the display panel 141 may be changed to the position where the object 701 has been output as the views of the object 701 are changed to coincide with each other as illustrated in the screen 703. The parallax of the object 702 may get larger as the vergence view changes.

As illustrated in the screen 705, the user may generate a touch event for vergence view adjustment in the upper-right area where the object 702 is positioned. The controller 160 may detect the view parameters of the upper-right area, and adjust the output form of the image frames in a direction that removes parallax values in the position. Accordingly, the display panel 141 may output images in the form where the parallax value of the object 702 has been removed as illustrated in the screen 707. Consequently, the portable terminal 100 may provide effects that the vergence view is moved to a position where the object 702 is located.

The controller 160 may control to detect objects whose boundary areas have been separated by scanning a certain area of where a touch event has occurred, and output image frames so that the separated boundary areas may coincide with each other. The controller 160 may control to automatically recognize the user's vergence view by operating a camera while a stereoscopic image is being output to the display panel 141, and to automatically remove the parallax of the position where user's vergence view is made by adjusting the output form, i.e., the output direction, angle and distance, etc. of image frames according to a change of vergence views. Stereoscopic images may be defined to be classified by layers, and the distance adjustment of image frames may correspond to distance adjustment between layers of image frames or order adjustment between layers.

The portable terminal 100 may further include various additional modules. For example, if the portable terminal 100 is a communication terminal, the portable terminal 100 may further include a near field communication module for near field communication, a camera module for photographing still images/moving pictures, an interface for data transmission and reception by a wired communication method or wireless communication method, an Internet communication module for performing Internet functions by communicating with an Internet network, and a digital broadcasting module for receiving a digital broadcast and performing a replay function, etc. Such components may vary according to a convergence trend of digital devices, and thus such components are not described here, but the components of a similar level as that of the above-mentioned components may be added to the device. It is also possible for certain components to be removed from the portable terminal 100 or substituted with other components in the portable terminal 100, as would be understood by those skilled in the art.

The portable terminal 100 according to an exemplary embodiment of the present invention may be any type of device including a display panel in which stereoscopic implementation is possible. For example, the portable terminal 100 may include all kinds of information communication devices and multimedia devices, such as a Portable Multimedia Player (PMP), a music player (e.g., an MP3 player), a portable game terminal, a smart phone, a notebook computer, and a handheld PC, etc. as well as all mobile communication terminals operated according to communication protocols corresponding to various communication systems.

As described above, according to a vergence control method for controlling a stereoscopic image display and a terminal supporting the same, exemplary embodiments of the present invention reduce eye strain according to focus separation and use various forms of display methods by adjusting the point desired by user as the vergence view.

While the invention has been shown and described with reference to certain exemplary embodiments thereof, it will be understood that by those skilled in the art that various changes in form and details may be made therein without departing from the spirit and scope of the present invention as defined in the appended claims and their equivalents.

What is claimed is:

1. A vergence control method for controlling a stereoscopic display, the method comprising:
reproducing a stereoscopic image;
receiving an input signal for vergence view adjustment of the stereoscopic image; and
adjusting a vergence view such that a position corresponding to the received input signal becomes the vergence view by removing a parallax of image frames of the position.

2. The method of claim 1, further comprising:
converting to a vergence adjustment mode by default setting or a user's request according to the stereoscopic reproduction request.

3. The method of claim 1, wherein the receiving of the input signal comprises:
receiving a touch event which indicates a certain area of a touch screen where the stereoscopic image is output.

4. The method of claim 1, further comprising:
activating a camera when reproducing the stereoscopic image;
photographing a user's eyes using the camera;
determining the user's vergence view based on iris positions of the eyes and a distance between terminals; and
generating an input signal for vergence view adjustment corresponding to the determined vergence view.

5. The method of claim 1, wherein the adjusting of the vergence view comprises:
detecting a view parameter of a position corresponding to the input signal for vergence view adjustment;
determining the parallax value of the view parameter; and
adjusting the image frames in order to remove the parallax value.

6. The method of claim 1, wherein the adjusting of the vergence view comprises:
scanning objects output in a certain area of a position corresponding to the input signal for vergence view adjustment; and
adjusting the image frames so that the boundary areas of the objects coincide with each other.

7. A terminal for supporting a vergence control for stereoscopic image display control, the terminal comprising:
a display panel for outputting a screen according to reproduction of a stereoscopic image; and
a controller for performing vergence view adjustment such that a position corresponding to a received input signal becomes a vergence view by receiving an input signal for vergence view adjustment of the stereoscopic image, and for removing a parallax of image frames of the position corresponding to the received input signal.

8. The terminal of claim 7, wherein the controller controls to convert into a vergence view adjustment mode by a default setting or a user's request according to the stereoscopic image display request.

9. The terminal of claim 7, further comprising:
a touch panel for generating a touch event indicating a certain area of a touch screen where the stereoscopic image is output, and for transmitting the generated touch event to the controller.

10. The terminal of claim 7, further comprising:
a camera for photographing a user's eyes,
wherein the controller determines user's vergence view based on the iris positions of the photographed eyes and the distance between terminals, and generates an input signal for vergence view adjustment corresponding to the vergence view.

11. The terminal of claim 10, wherein the controller controls to activate the camera when reproducing the stereoscopic image.

12. The terminal of claim 7, wherein the controller comprises:
an image replay unit for reproducing the stereoscopic image;
a vergence view adjustment detection unit for collecting input signals for the vergence view adjustment; and
a vergence adjustment unit for adjusting the vergence view according to the input signals for the vergence view adjustment.

13. The terminal of claim 12, wherein the vergence adjustment unit comprises:
a view parameter detection unit for detecting a view parameter of a position corresponding to the input signal for vergence view adjustment; and
a vergence adjustment unit for determining the parallax value of the view parameter and adjusts the image frames to remove the parallax value.

14. The terminal of claim 7, wherein the controller scans objects output in a certain area of a position corresponding to the input signal for vergence view adjustment, and adjusts the image frames such that the boundary areas of the objects coincide with each other.

15. The terminal of claim 7, wherein the terminal is a portable terminal.

16. The terminal of claim 7, further comprising:
an input unit for receiving the input signal from a user.

17. The terminal of claim 16, wherein the input unit is a touch screen integrated with the display unit.
